(19) United States
(12) Patent Application Publication
(10) Pub. No.: US 2003/0203340 A1
(43) Pub. Date: Oct. 30, 2003

(54) Trace and erase supplementary education system

(76) Inventor: Max Kees, Temple, TX (US)

Correspondence Address: DAVID G. HENRY, 7th Floor, 900 Washington Avenue, P.O. Box 1470, Waco, TX, 77603-1470, US

(21) Appl. No.: 10/133,207

(22) Filed: Apr. 26, 2002

(51) Int. Cl. G09B 11/04

(52) U.S. Cl. 434/88

(57) ABSTRACT

An educational system including a binder with multiple worksheet or tracing specimens, a clear plastic overlay sheet pivotally attached to the binder to overlie the particular worksheet which is to be used. The plastic overlay is movable to allow the change of worksheets, after which the overlay can be moved to lie atop the worksheet. Dry-erase markers are provided for writing on the plastic overlay, rather than the worksheet.

### BACKGROUND OF THE INVENTION

1. Field of the Invention

The present invention relates to educational accessories and to writing and drawing instruments and substrates for writing and drawing.

2. Background Information

Two primary topics are relevant to the needs which underlie the present invention.

A. School Operating Expense

Schools, be they public or private, are ever more pressed for adequate funding to provide quality education for students. The consumption of workbooks, worksheets, writing tablets, and the like constitutes one significant component of school operating expenses.

In even some of the most affluent school districts, students share textbooks, and are told not to fill in the blanks of worksheets, but to answers to worksheets (which are intended to be consumable items) on blank paper.

Computer-based student interaction represents one possible solution to the consumption of paper-based worksheets and the like. Using such technology, students can interactively complete “worksheets” by “answering” the computer's questions.

While computer-based educational tools are quite effective, they are also quite expensive. A school which is struggling to buy adequate consumable worksheets will rarely have resources for buying sufficient computers for each student's simultaneous use.

It would well serve schools and educators to provide a system or tool that: (1) eliminates the consumption of worksheets for student practice and study; and (2) does not require the purchase of expensive equipment (such as computers) to implement.

B. Kinesthetic Development Needs of Students

Students, particularly young students, develop dexterity as needed for writing, keyboard skills, and art activities primarily by practicing their motor skills and their hand-eye coordination.

Whether by tracing pictures or cursive letters, tracing pre-printed graphical material is one proven way to “imprint” motor control skills for a students. Even if the student does not yet fully understand what they are “writing”, the act of simply tracing words, letters and numbers, as well as figures, helps students in the motor skills and hand-eye coordination development.

Notwithstanding the tremendous positives related to tracing work, the consumption of materials involved in carrying out the activity often results in the activity being overlooked.

It would, therefore, well serve schools and educators to provide a tool or system which provided children with materials and tools for educator-designed tracing practice, but which did not consume paper materials, nor require expensive computer-based equipment or supplies.

### SUMMARY OF THE INVENTION

In view of the foregoing, it is an object of the present invention to provide a supplementary education system which eliminates consumption of worksheets and other consumable, paper-based education supplies.

It is another object of the present invention to provide an educational tool which provides for tracing practice for students, but which does not consume worksheets and other consumable, paper-based education supplies.

It is another object of the present invention to provide an educational tool which obviates the need for computer-based educational equipment, yet provides the cost benefits from lack of consumption of paper-based worksheets as do computer systems.

It is another object of the present invention to provide an educational tool that is enjoyable for students to use, and, therefore, more likely to keep their attention during important training activities.

In satisfaction of these and related objects, the present invention provides a tracing and re-usable worksheet system which, while very simple in concept and design, satisfies each of the above objects.

The system of the present invention includes, in its preferred embodiment, a binder with multiple worksheet or tracing specimens (hereafter referred collectively to as “worksheets”). A clear, most likely plexiglass-like sheet is pivotally attached to the binder to overlie the particular worksheet which is to be used. The plastic overlay is movable in such a way as to allow the change of worksheets, after which the overlay can be moved to lie atop the worksheet. Dry-erase markers are provided for writing on the plastic overlay.

Several modes of use are instructive in the benefits of the present system.

In the case of tracing practice for aiding in kinesthetic development, a figure or series of letters or numbers will appear on a particular worksheets, or series of worksheets. The assigned worksheet will be brought to the top of the stack of worksheets, and the plastic overlay will be moved into position for use. The student then simply traces over the image of the worksheet which he or she can readily see through the clear plastic.

When the student has completed the worksheet, he or she can erase the markings on the plastic overlay and turn to a new worksheet, or repeat the practice on the same worksheet.

Another illustrative use of present system, particularly as relates to reducing consumption of worksheets, etc., comes in the context of math worksheets. In this context, a particular worksheet will, for example, have a series of math problems with boxes in which the student is to write the answer (on the overlying plastic overlay). The next worksheet will show the answers to the problems, with the answers being positioned on the second worksheet to appear next to the answers that the student wrote on the plastic overlay, thus allowing self-checking and immediate feedback, unlike that provided by the much more expensive computer-based systems.

Of course, the same method as just described for math problems can be used in grammar, chemistry problems, or just about any subject matter where answers are written during use of a first worksheet, and the correct answers appear on a second worksheet positioned next to where the answers were to be placed while using first worksheet.

Some might initially criticize such an approach to practice or quizzing, because one might assume that at least some students would simply look at the second, answer worksheet and lose the benefit of actually working the problems. As will be apparent from a review of the Detailed Description to follow, the structure of the present system, in its preferred embodiment, would make such subterfuge quite difficult to carry out without notice of the teacher. Moving from one worksheet to another involves pivoting the plastic overlay out of its use position, turning the page, and returning the plastic overlay to its use position. Also, the plastic overlay prevents “peeking” at the next page, again, as will be apparent from a review of the preferred construction of the present system.

Although the present system has been described in relation to use with younger children, it should be pointed out that it could also be used in rehabilitation work, by agencies who are often even more strapped for funds than schools. Certain head injuries results in victims having to re-train their brains to do certain voluntary, physical tasks, including writing. In such cases, the present system could be of great benefit.

### BRIEF DESCRIPTION OF THE DRAWINGS

FIG. 1 is a perspective view of the educational system of the preferred embodiment.

### DETAILED DESCRIPTION OF THE PREFERRED EMBODIMENT

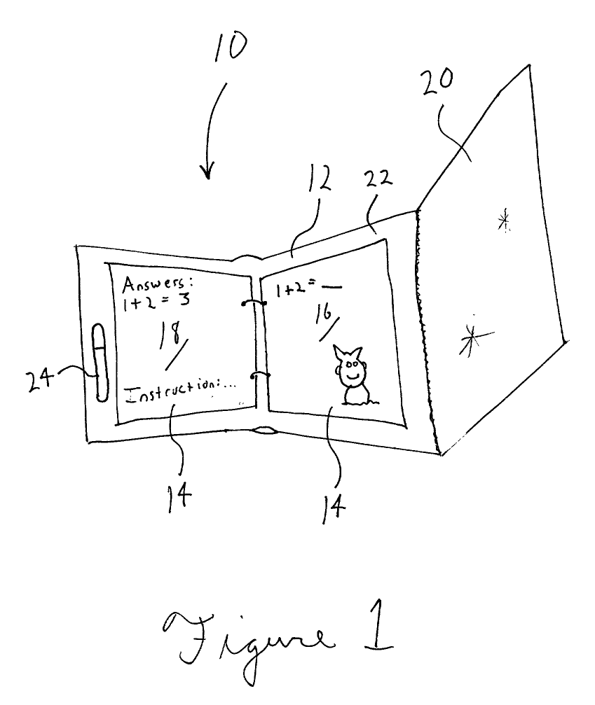

Referring to FIG. 1, the trace and erase system of the present invention is identified generally by the reference number 10. System 10, in its preferred embodiment, includes a loose leaf binder 12 for allowing the exchange of worksheets 14.

Worksheets 14 are printed with indicia on only one, front side 16 for most uses, although certain embodiments, or certain worksheets in certain embodiments, may have indicia printed on the back side 18 for one of two primary purposes: (1) to provide comments or answers pertaining to the worksheet just completed (on the front side of the same sheet); or (2) to provide instructions, examples, etc. for the next worksheet which would now be facing the user.

A clear, plastic overlay 20 is, in the preferred embodiment, hingedly attached to the margin of the right hand cover 22 of binder 12 (for use in populations which do not read from left to right, top to bottom, this arrangement may be altered). Overlay 20 is sized and shaped to wholly overlay worksheets 14 residing to the right side of the binding rings of binder 12.

A dry-erase marker 24 is provided and is to be used to mark answers, or practice tracing or other drawing or writing skills on overlay 20.

Note that overlay 20, when in the use position (overlaying a worksheet which is face-up to the right of the binding rings of binder 12) prevents access to subsequent worksheets 14 (or the rearward side 18 of worksheet 14 that is in use), such access being only possible if overlay 20 is pivoted to the worksheet exchange position (pivoted away from the space occupied by in-use worksheets 14). This prevents student cheating in the case of system 10 being used with questions or problem on a first worksheet 14, and answers on a second worksheet 14.

Clearly, alternatives to the specific embodiment just described are possible. For example, some other removable (or even non-removable binder system may be used in lieu of a true looseleaf binder. Also, the plastic overlay may be attached to binder 12 in any number of ways, both in a hinged-like manner, or even a sliding arrangement in a frame-like structure. Nevertheless, the embodiment described is believed to be the very best over-all design with respect to both utility, convenience and cost-effectiveness as relates to cost of manufacture and acquisition.

Therefore, although the invention has been described with reference to specific embodiments, this description is not meant to be construed in a limited sense. Various modifications of the disclosed embodiments, as well as alternative embodiments of the inventions will become apparent to persons skilled in the art upon the reference to the description of the invention. It is, therefore, contemplated that the appended claims will cover such modifications that fall within the scope of the invention.

I claim:

1. An educational tool comprising:
a plurality of worksheets with printed indicia appearing on at least a front side thereof;
binder means with worksheet retainer means for retaining said worksheets in alternative, interchangeable use and non-use positions;
substantially transparent overlay means moveably attached to said binder means, said overlay means being positioned and attached whereby said overlay means moves from a first position to overlay one said worksheet when in said use position, to a second position spaced apart from said one worksheet.

2. The education system of claim 1 wherein said binder means is a looseleaf binder with right and left side covers, said worksheets are retained on binder rings of said binder, said overlay means being pivotally attached to a margin of said binder whereby said overlay means will overlay a said worksheet while said worksheet resides on one side of said binder's interior.
